(19) United States
(12) Patent Application Publication
(10) Pub. No.: US 2009/0151579 A1
(43) Pub. Date: Jun. 18, 2009

(54) Doctor Blade Apparatus For Printing Press

(75) Inventor: Koji Sumiyoshi, Nagareyama-Shi (JP)

Correspondence Address: FOX ROTHSCHILD LLP, P O BOX 592, 112 NASSAU STREET, PRINCETON, NJ, 08542-0592, US

(73) Assignee: CHIBA MACHINE INDUSTRY CORPORATION, Chiba (JP)

(21) Appl. No.: 11/956,383

(22) Filed: Dec. 14, 2007

(51) Int. Cl. B41F 9/10

(52) U.S. Cl. 101/169

(57) ABSTRACT

The invention is to cope with the minute liquid pressure change due to drying of ink or paint, clogging due to minute dirt, and other problems occurring at the tip of the doctor blade by controlling the curvature of the doctor blade itself by applying a pressure in the direction perpendicular to the surface direction of the doctor blade located in the doctor holder, thus finely adjusting the tip of the doctor blade.

### BACKGROUND

1. Technical Field

The present invention relates to a doctor blade apparatus for printing presses, for example, printing presses for gravure printing or flexo printing and coaters such as gravure coaters and roll coaters, in particular, those that are capable of adjusting the position, angle and pressure of the doctor blade.

2. Description of Related Art

Printing presses and coaters are generally equipped with doctor blade apparatuses. A doctor blade apparatus has a doctor blade made of a thin, flat plate material for scraping off excessive ink coated on the plate surface of a plate roll, and is capable of finely adjusting the position, angle and pressure of the doctor blade relative to the plate roll with the help of a spring, an air cylinder and the like in order to prevent such problems as “scratches,” “plate smearing,” “coating unevenness,” “coating streaks,” etc.

For example, one such apparatus for gravure printing presses is disclosed in Publication of Unexamined Patent Application No. JP(A) 2001-287335. This apparatus is to scrape off excessive ink by means of two doctor blades placed adjacent to each other: a doctor blade A located ahead of the other and a doctor blade B located behind the other relative to the rotating direction of the plate roll.

This apparatus sets up a higher pressure for the doctor blade A than the pressure for the doctor blade B to make the two stage ink scraping action more secure, in order to prevent “degradation of ink cutting sharpness in the doctor blade,” which may be caused by insoluble substances of water-soluble ink depositing in the ink, and “scratches,” “plate smearing,” etc.

Another apparatus for letterpresses is disclosed in Publication of Unexamined Patent Application No. JP(A) H8-207231. This apparatus is capable of adjusting the operating stroke of a doctor blade, which is displaceable relative to the plate roll. This apparatus has a motor-driven rotary tilting plate affixed to a frame that drives the doctor blade in conjunction with a displaceable beam and is capable of adjusting the operating stroke of the doctor blade by means of setting the degree of the motion of the rotary slanting plate through a hand wheel connected to the adjusting lever. In this apparatus, the doctor drive mechanism can be operated more easily and can be adjusted by a continuous operation even in case of a short operating stroke of the doctor blade.

However, it is impossible to adjust delicate contacting relations between the doctor blade and the plate roll in these doctor blade apparatuses, so that they cannot cope with minute hydraulic pressure changes that may occur due to drying of ink and paint or cannot remove fine dirt that is clogging at the tip of the doctor blade. The contact condition between the tip of the doctor blade and the plate roll is extremely sensitive so that the mechanical constitution of the elasticity of the doctor blade itself or the rotary tilting plate as mentioned above is not enough for the necessary adjustment, thus making it impossible to prevent the aforementioned printing problems securely.

### SUMMARY

The first objective of the present invention is to make fine adjustments of the position, contact pressure, and contact angle of the tip of the doctor plate relative to the surface of the plate roll (hereinafter referred as “plate surface”) possible in order to eliminate ink scratching, plate smearing, coating unevenness, coating streaks and other problems securely and easily.

The second objective of the present invention is to make it possible to cope with the problems such as minute hydraulic pressure changes that may occur due to drying of ink and paint or removal of fine dirt that is clogging at the tip of the doctor blade.

The present invention for accomplishing the abovementioned objective is a doctor blade apparatus having a doctor blade made of a thin flat plate material, a doctor holder that hold the doctor blade in such a way as to make its tip abut against a plate surface, and an adjusting unit attached to the doctor holder and is used to adjust its position or angle, wherein the adjusting unit has a fine adjustment mechanism that applies a pressure to the doctor blade from a direction perpendicular to the surface direction of the doctor blade located inside the doctor holder in order to control the degree of curving of the doctor blade itself so that the contact condition between the tip and the plate surface can be finely adjusted.

Applying a pressure in the direction perpendicular to the doctor blade's surface thus causing the doctor blade itself to curve makes it possible to adjust the position, contact pressure, and contact angle of the tip of the doctor blade relative to the surface of the plate surface, so that it can solve various problems that may occur at the doctor blade's tip in one stroke without affecting the printed material or the coating accuracy. In particular, while the contact condition between the doctor blade's tip and the plate roll is extremely sensitive, the relation between the plate surface and the doctor blade can be finely adjusted by applying a pressure from the direction perpendicular to the doctor blade's surface to cause the doctor blade itself to curve, as the curving affects the doctor blade's tip.

For example, it enables us to eliminate “scratches,” “plate smearing,” “coating unevenness,” “coating streaks,” etc. securely and easily when it is used on printing presses for gravure printing or flexo printing, and coaters such as gravure coaters and roll coaters. Moreover, it makes it possible to cope with the problems such as minute hydraulic pressure changes that may occur due to drying of ink and paint or removal of fine dirt that is clogging at the tip of the doctor blade. Furthermore, it makes it possible to apply a uniform pressure along the width direction of the plate roll even if there is a curving or distortion caused in attaching the doctor blade or if there is any curving of the doctor holder itself.

The fine adjustment mechanism is connected to a pressure source via a pressure control valve and is characterized in that it has a single or plurality of flexible tube members that are capable of expanding in the outer diametrical direction of shrinking in the inner diametrical direction in accordance with the supply pressure of the pressure source.

If the doctor blade is made to curve with the help of the flexible tube members, it is possible to make a fine adjustment of the position, contact pressure and contact angle of the doctor blade's tip even in case of an extremely sensitive doctor blade made of thin flat plate member, thus making it possible to cope with the delicate hydraulic pressure change in the contact between the doctor blade's tip and the plate roll and the task of eliminating fine dirt that is clogging.

The fine adjustment mechanism is characterized in that the flexible tube member is provided at least one side of the doctor blade.

While the flexible tube is preferably placed on one side of the doctor blade, i.e., on the side opposite to the direction the doctor blade is curved by the rotation of the plate roll, but it is also possible to provide it on either side of the doctor blade or on both sides of the doctor blade.

In such a case, it is preferable to provide an adjustment cavity on the doctor holder to serve as a relief space for the doctor blade on the side opposing the flexible tube member.

When applying a pressure on the doctor blade to cause it to curve by the flexible tube member, the provision of the relief space makes it easier for the doctor blade to curve, hence making it easer to finely adjust the curving of the doctor blade's tip. In particular, the provision of this adjustment cavity makes it possible to increase the range of curvature of the doctor blade by the flexible tube member, so that it is possible to control the degree of curvature of the doctor blade itself, which is caused by the rotation of the plate roll, for a wider range.

The doctor blade can be provided with at least one enforcement plate for enforcing the doctor blade on one side or both sides. Providing an enforcement plate on the doctor blade can prevent the doctor blade from causing plastic deformation due to flexing instead of smooth bending when the doctor blade curves in accordance with the rotation of the plate roll, and can prevent it from fracture as a result. In particular, if an enforcement plate is added to the doctor blade surface side that abuts against the flexible tube member, in addition to the side opposite to the doctor blade that faces the flexible tube member, it enhances the strength of the think doctor blade and can securely prevent the plastic deformation and fracture mentioned above.

Since the fine adjustment mechanism detects the pressure inside the flexible tube member by a pressure sensor and the controller controls the operation of the pressure control valve based on the electrical signal from the pressure sensor, any pressure change inside the flexible tube can be accurately controlled and the fine adjustment of the contract pressure and contact angle of the doctor blade tip against the plate roll can be automatically controlled. As a result, it is possible to constitute a super-high sensitivity doctor system that can eliminate ink scratching, plate smearing, coating unevenness, coating streaks and other problems securely and easily.

### BRIEF DESCRIPTION OF THE DRAWINGS

FIG. 1 is a general side view of the best embodiment of the invention as it is attached to a printing press doctor showing its essential portion.

FIG. 2 is a general plan view of the doctor showing its essential portion.

FIG. 3 is a cross-sectional view of the essential portion of an example of the fine adjustment mechanism of the doctor.

FIG. 4 is a cross-sectional view of the essential portion of the doctor when its enforcement plate is removed.

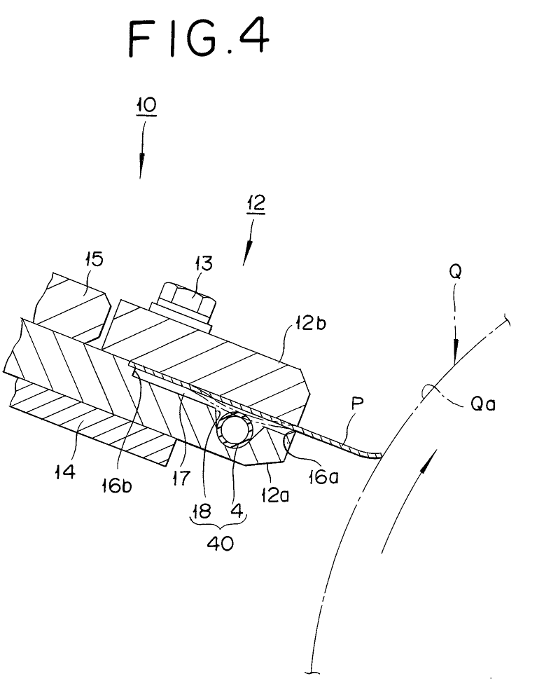

FIG. 5 is a schematic drawing showing an example of the circuit for supplying pneumatic pressure to the fine adjustment mechanism.

FIG. 6 is a drawing for describing the doctor's operating condition by the fine adjustment mechanism, where (A) shows the status before the printing is operated and (B) shows the status when the printing press is in operation.

### DESCRIPTION OF THE PREFERRED EMBODIMENT

The optimum embodiment condition will be described below referring to the accompanying drawings.

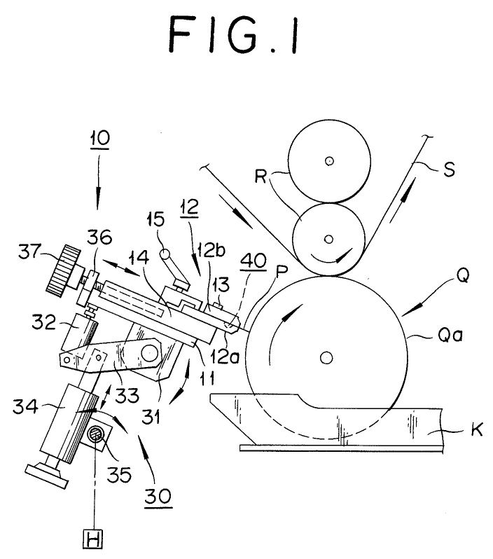

In FIG. 1, a doctor mounted on a gravure printing press has a main unit 10 that is provided in such a way as to approach a plate surface Qa of a plate roll Q in an oblique angle, an adjusting unit 30 that adjusts the position or angle of a doctor blade P via a doctor holder 12 attached to the main unit 10, and a fine adjustment mechanism 40 that further finely adjusts the condition of the tip of the doctor blade P helping the adjustment by the adjusting unit 30.

The plate roll Q is immersed in water-soluble and other types of printing ink stored in an ink pan K, and a base material film S wrapped around one of the pressure rollers R is pressed against the plate surface Qa of the periphery of the plate roll.

As shown in FIG. 1, the adjusting unit 30 has a bracket 31 that hangs down from the front edge side of a base plate 11 provided on the main unit 10 as described later, a fixed shaft member 32 with adjustable hang down length that hangs down from the rear edge side of the base plate 11, an arm 33 that is connected rotatably to both the bottom end of the fixed shaft member 32 and the bracket 31, an axially extendible cylinder member 34 whose tip is connected to the arm 33, rotating parts H (manual operation or pneumatic cylinder etc.) that rotates the cylinder member 34 around a shaft 35 provided on the side of the cylinder member 34, and a screw mechanism 37 that is provided on a bracket 36 mounted on the rear end of the base plate 11 and moves a guide member 14 towards/away from plate roll Q.

The adjusting unit 30 thus constituted makes adjustment in such a way as to cause the tip of the doctor blade P to abut against the plate surface Qa of the plate roll Q with a specified contract pressure and at a specified angle Q by determining an approximate angle position relative to the plate roll Q by the rotating parts H, determining the height position relative to the plate roll Q by the cylinder member 34, and determining the forward/backward position relative to the plate roll Q by the screw mechanism 37.

However, it goes without saying, that this adjusting unit 30 is only one example and the invention is not limited to it, but rather various other apparatuses can be used for the same purpose.

The main unit 10 has a base plate 11, a guide member 14 provided on the base plate 11, and a doctor holder 12 that is provided on the guide member 14 and holds the doctor blade P.

The guide member 14 is supported by support members 14a attached on the base plate 11, and is slidably mounted as to allow it to approach to or move away from the plate roll Q. The sliding motion of the guide member 14 relative to the base plate 11 is driven by the screw mechanism 37.

The doctor holder 12 has, as shown in FIG. 1 through FIG. 3, a base holder part 12a below and a cover holder part 12b above, being tied by bolts 13 together with the doctor blade P sandwiched between the two holder parts 12a and 12b, and the base holder part 12a is mounted to the guide member 14 removably by a clamp mechanism 15.

The base holder part 12a has a generally recessed wide groove-like adjustment cavity 17 formed for the entire width of the top surface comprising stepped parts 16a and 16b formed on the front end side and the rear end side respectively. While these stepped parts 16a and 16 bare both intended to support the doctor blade P as described later, it is preferable that the front end stepped part 16a have a pointed end so that it makes a line contact with the doctor blade P.

The fine adjustment mechanism 40 is provided toward the tip of the adjustment cavity 17. While the adjusting unit 30 is installed with the doctor blade P maintaining a specified accuracy relative to the plate roll Q, the relation between the tip of the doctor blade P and the plate roll Q cannot be adjusted not only when it is installed but also throughout its usage period. Therefore, it makes it impossible to cope quickly with the problems such as minute hydraulic pressure changes that may occur due to drying of ink and paint or removal of fine dirt that is clogging at the tip of the doctor blade P. Thus, in this embodiment, the fine adjustment 40 is provided to adjust finely the position of the tip of the doctor blade P and the like.

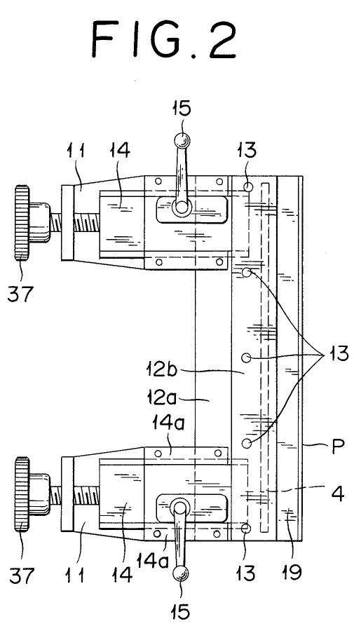

The fine adjustment mechanism 40 generally applies a pressure to the doctor blade P from a direction that is perpendicular to the surface direction of the doctor blade P placed within the doctor holder 12 in order to control the curvature of the doctor blade P, and it is constituted with a flexible tube member 4 (shown by dashed lines in FIG. 2) having an approximately cylindrical shape that applies a pressure to the doctor blade P inside a storage cavity 18 formed for the entire width of be base holder part 12a in this embodiment.

Let us further discuss in detail. First, the doctor blade P is made of a thin flat metal plate. For example, it is made of a SUS material (stainless steel plate) having a thickness of 0.1 mm-0.3 mm and a width of 1500 mm-2 000 mm.

The flexible member 4 is a thin-walled tube made of an elastic material such as rubber, nylon, urethane etc., having a wall thickness of 0.1 mm-5 mm, and an outer diameter of 5 mm-30 mm when it is not inflated.

The doctor blade P is mounted on the adjustment cavity 17 in such a way that a portion of its tip is projecting ahead of the base holder 12a from the top of the flexible tube member 4, which is inserted in the storage cavity 18 of the base holder part 12a. The amount of this projection is approximately 5 mm in case of the plate shown above.

A thin enforcement plate 19 of a rectangular shape is provided on the top side of the doctor blade P, and the enforcement plate 19 is covered by the cover holder part 12b, which is affixed by bolts 13 or other fastening means. By doing this way, the doctor blade P can be held in a two-point support condition by the front and rear stepped parts 16a and 16b.

The tip of the enforcement plate 19 is projecting from the tip of the doctor holder 12, but it is kept shorter than the projection length of the doctor blade P. By doing this way, the doctor blade P can be bent as its tip abuts against the plate surface Qa as it is held by the enforcement plate 19.

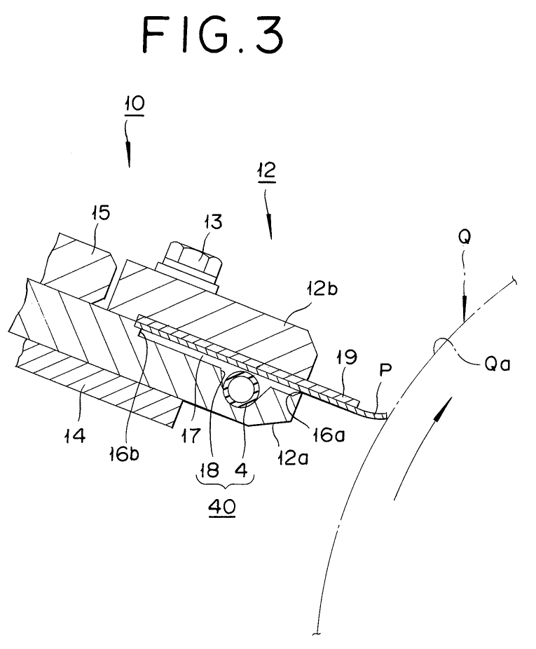

In order to further increase the reinforcement of the thin doctor blade P, another enforcement plate (not shown) can be added to the underside of the doctor blade P. Depending on the plate thickness of the doctor blade P, it may not be necessary to provide any of the top enforcement plate 19 or the underside enforcement plate. If no enforcement plate is used, place the cover holder 12b directly after installing the doctor blade P in the adjustment cavity 17 of the base holder 12a as shown in FIG. 3, and fasten them with the bolts 13.

If there is no need for enforcing the doctor blade P, it can be arranged in such a way as to provide an adjustment cavity (not shown) on the cover holder part 12b as well, similar to the adjustment cavity 17 formed on the side of the base holder part 12a in order to provide a relief on the upper side of the doctor blade P so that the bending range width of the doctor blade P by the flexible tube member 4 can be increased.

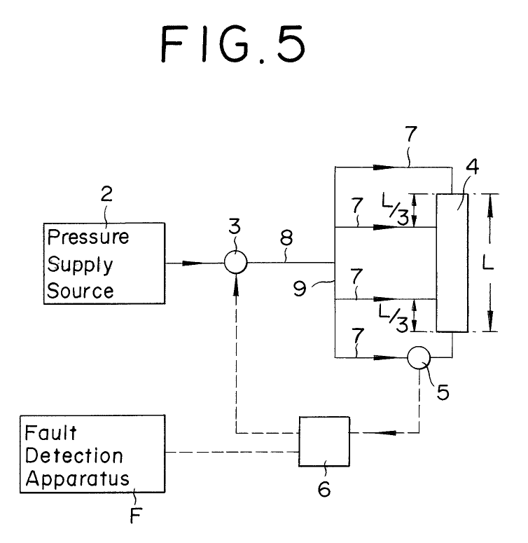

The flexible tube member 4 is constituted in such a way as shown in FIG. 5 that the fluid from the pressure supply source 2 is supplied into the inside of the flexible tube member 4 in a distributed way by a plurality of supply tubes 7. The fluid to be used can be, in addition to compressed air, hydraulic oil and pressured water.

The fluid from the fluid supply source 2 is fed through a feed pipe 8, a manually or automatically controllable pressure regulating valve 3 provided in the transmission path of the feed pipe 8, and a header pipe 9 to each supply pipe 7. The pressure regulating valve 3 has a function of controlling the fluid from the pressure supply source 2 to a specified pressure and also a function to adjust the internal pressure of the flexible tube member 4 by relieving the fluid from each supply pipe 7. As a consequence, the flexible tube member 4 can expand in the outer diametrical direction or shrink in the inner diametrical direction.

More specifically, as shown in FIG. 2, the tube member 4 per se has a long axial length L as shown in FIG. 5 due to the fact that the doctor blade P expands widely. Therefore, in order to supply the pressure into the flexible tube member 4 efficiently, the supply pipe 7 consists of, for example, four pipes, and is connected to both ends of the flexible tube 4 as well as to ⅓ L and ⅔ L positions on the peripheral side.

Furthermore, one of the branches of the supply pipe 7 is provided with a pressure sensor 5 for converting the internal pressure of the flexible tube member 4 into an electrical signal, and the pressure sensor 5 and the pressure control valve 3 are connected via a controller 6. Therefore, it is possible to control the inner pressure of the flexible tube member 4 automatically by operating the pressure control valve 3 based on the electrical signal from the pressure sensor 5 received at the controller 6.

A fault detection apparatus F provided on the printing press is also connected to the controller 6. The fault detection apparatus F is, for example, a CCD camera, for detecting printing faults such as plate smearing, plate smearing, plate unevenness and streaks. Therefore, when the fault detection apparatus F detects a printing fault, the controller 6 receives the detection signal issued by the fault detection apparatus F, controls the doctor blade P, and make sure that no fault occurs the printed material thereafter. It can be so arranged as to operation other devices to remove the printed materials with faults when the detection signal from the fault detection apparatus F is received.

The adjustment of the pressure inside the flexible tube 4 can be controlled manually by operating the pressure control valve 3 without recourse to the automatic control of the controller 6, directly adjusting the compressed air from the pressure supply source 2 and the pressure of operating fluid, etc.

The flexible tube member 4 is not limited to one, but rather a plurality of them can be provided in the front and rear direction of the doctor blade P and make the plurality of flexible tube member 4 to abut against the underside of the doctor blade P. In this case, a plurality of the storage cavities 18 can be formed, and have a flexible tube member 4 be stored in each of the storage cavities 18, or a plurality of flexible tube members 4 can be stored in a single storage cavity 18.

Next, let us describe the assembly, use, and operation of the present embodiment.

In FIG. 3, the flexible tube member 4 is inserted into the storage cavity 18 of the base holder pat 12a, and the doctor blade P is installed to cover the adjustment cavity 17 of the flexible tube member 4.

Next, after the enforcement plate 19 is loaded on the upper side of the doctor blade P, the cover holder part 12b is placed to cover the base holder part 12a to be affixed by the bolts 13. At this time, the doctor blade P is supported at two points by the stepped part 16a and 16b and a part of the tip is slightly projecting forward of the doctor holder 12.

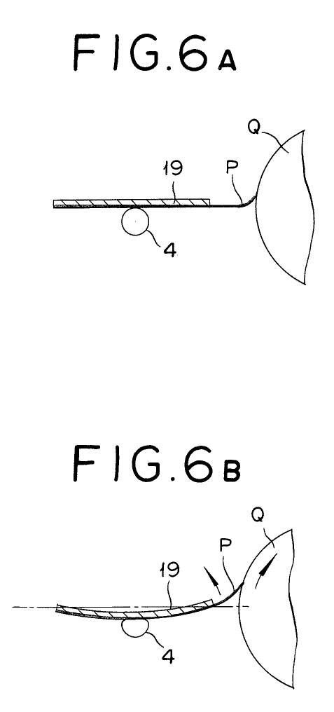

The doctor is adjusted by means of the adjusting unit 30 in such a way that the tip of the doctor blade P abuts against the plate surface Qa of the plate roll Q. The detail of the adjustment is omitted here. As a result of the adjustment, the doctor blade P is in the condition of abutting against the plate surface Qa of the plate roll Q as showing in FIG. 6 (A) and it is approximately straight without a bend, but it can be slightly bent as well.

Rotate the plate roll Q in the clockwise direction as shown in FIG. 6 (B) while the doctor blade P abuts against the plate surface Qa, and operate the fine adjustment mechanism 40 to supply compressed air to the flexible tube member 4.

The doctor blade P then deforms to curve due to the friction force between it and the plate surface Qa, and curves into a bow-shape or an arc shape downward with the stepped part 16a as a fulcrum inside the holder part 12.

Such a deformation of the doctor blade P inside the holder part 12 causes the inflated flexible tube member 4 below to collapse and changes the internal pressure of the flexible tube member 4. This pressure change is detected by the pressure sensor 5, which is then transmitted to the controller 6 as the pressure signal, and the controller 6 controls the pressure control valve 3. When the fault diction apparatus 9 detects faults such as scratch, plate smearing, unevenness, and streak caused by the plate roll Q, the detection signal enters the controller 6, based on which the pressure control valve 3 is controlled.

As the inner pressure of the flexible tube member 4 is delicately controlled by the pressure control valve 3, the curving condition of the doctor blade P is controlled by the flexible tube member 4 in turn, which affects the tip of the doctor blade P, and the contact pressure and the contract angle of the tip of the doctor blade P against the plate roll Q are minutely varied and finely controlled.

As a result, if any odd object exists between the tip of the doctor blade P and the plate roll Q, or if any solid object is generated due to drying of printing ink or paint, they will be removed securely.

The present invention is not limited in any way be the embodiment described above, but rather it can be applied in various different ways within the scope of the claims. For example, it goes without saying that the invention can be applied to coaters such as a flexo printing, a gravure coater or a roll coater, although the description of the embodiment above used a gravure printing press as an example.

1. A doctor blade apparatus for printing presses comprising:
a doctor blade made of a thin flat plate material;
a doctor blade holder that holds the doctor blade in such a way as to make the doctor blade tip abut against a plate surface; and
an adjusting unit attached to the doctor blade holder and is used to adjust the doctor blade position or angle of the doctor blade,
wherein said adjusting unit has not more than a single fine adjustment mechanism that applies a pressure to said doctor blade from a direction perpendicular to the surface direction of the doctor blade located inside said doctor holder in order to control the degree of curving of said doctor blade itself so that the contact condition between the tip and said plate surface can be finely adjusted.

2. The doctor blade apparatus for printing presses according to claim 1 wherein said fine adjustment mechanism comprising:
a pressure source, and not more than one flexible tube member being connected to the pressure source via a pressure control valve and being capable of expanding in the outer diameter direction of shrinking in the inner diameter direction in accordance with the supply pressure of the pressure source.

3. The doctor blade apparatus for printing presses claimed in claim 2 wherein said fine adjustment mechanism is characterized in providing said flexible tube member at least on one side of said doctor blade.

4. The doctor blade apparatus for printing presses according to claim 2 wherein said fine adjustment mechanism is provided said flexible tub member on the opposite side of the direction said doctor blade is curved as a result of the rotation of said plate roll.

5. The doctor blade apparatus for printing presses according to claim 2 wherein said fine adjustment mechanism is provided an adjustment cavity that serves as a relief for said doctor blade at a location opposing said flexible tube member on said doctor holder.

6. The doctor blade apparatus for printing presses according to claim 2 wherein said fine adjustment mechanism is provided at least one enforcement plate for reinforcing said doctor blade at least on one side of said doctor blade.

7. The doctor blade apparatus for printing presses according to claim 2 wherein said fine adjustment mechanism comprising:
a pressure sensor for converting said flexible tube member's internal pressure into an electrical signal; and,
a controller for operating said pressure control valve based on the electrical signal from said pressure sensor;
wherein said controller controls the variation of said flexible tube member's internal pressure.
